(19) United States
(12) Patent Application Publication
(10) Pub. No.: US 2020/0370909 A1
(43) Pub. Date: Nov. 26, 2020

(54) DISPLAY DEVICE, DISPLAY SYSTEM, AND DISPLAY METHOD

(71) Applicant: KYOCERA Document Solutions Inc., Osaka (JP)

(72) Inventor: Hideki ITO, Osaka (JP)

(73) Assignee: KYOCERA Document Solutions Inc., Osaka (JP)

(21) Appl. No.: 16/767,957

(22) PCT Filed: Dec. 1, 2017
(86) PCT No.: PCT/JP2017/043344

§ 371 Date: May 28, 2020

(51) Int. Cl. G01C 21/34; G01C 21/36

(52) U.S. Cl. CPC G01C 21/3476; G01C 21/3691; G01C 21/343

(57) ABSTRACT

A display input device has: an operation display portion that displays a state image indicating the state of a facility at the location of the facility on a map; and a control portion that sets a future date and time as a target date and time, that recognizes the state of the facility at the target date and time based on schedule information, and that displays the state image corresponding to the state of the facility at the target date and time on the operation display portion.

### TECHNICAL FIELD

The present invention relates to a display device, a display system, and a display method for displaying a state image indicating a state of a facility.

### BACKGROUND ART

Conventionally, there are known display devices that display a state image indicating a state of a facility. Such a display device is disclosed, for example, in Patent Document 1.

According to Patent Document 1, a mobile telephone terminal is used as a display device. The display device is communicably connected to a server. The server is communicably connected to a cash register installed in a facility (store), and acquires business information on whether the facility is currently open (whether the facility is in its business hours).

The server transmits location and business information on the facility to the display device. The display device, based on the business information, recognizes whether the facility is currently open and displays a map based on map information. Here, the display device, when the facility is currently open, displays a state image (filled circle) indicating so at the location of the facility on the map, and when the facility is currently closed, displays a state image (filled square) indicating so at the location of the facility on the map.

### LIST OF CITATIONS

### Patent Literature

Patent Document 1: Japanese Patent Application published as No. 2011-48719.

### SUMMARY OF THE INVENTION

### Problem to be Solved by the Invention

According to Patent Document 1, the content of business information changes depending on whether the power to a cash register is on or off. When the power to the cash register is on, business information indicating that the facility is currently open (in business hours) is transmitted from the cash register to the server. When the power to the cash register is off, business information indicating that the facility is currently closed (not in business hours) is transmitted from the cash register to the server.

Thus, according to Patent Document 1, it is possible to report the current state of a facility (whether it is currently open) to a user of the display device. Here, some user may want to know a future state of the facility. However, according to Patent Document 1, it is not possible to report a future state of the facility.

The present invention is made to solve the above problem and its object is to provide a display device, a display system, and a display method which can report a future state of a facility to a user.

### Means for Solving the Problem

In order to achieve the above object, a display input device according to a first aspect of the present invention includes: an operation display portion which displays a map and which displays a state image indicating the state of a facility at the location of the facility on the map; and a control portion which sets a future date and time as a target date and time, recognizes the state of the facility at the target date and time based on schedule information of the facility, and displays the state image corresponding to the state of the facility at the target date and time on the operation display portion.

A display system according to a second aspect of the present invention includes a display input device and a server which is communicably connected to the display input device and which stores schedule information of the facility. The display input device communicates with the server to refer to the schedule information of the facility when the display input device recognizes the state of the facility at the target date and time.

A display method according to a third aspect of the present invention is a display method for displaying a map and displaying a state image indicating the state of a facility at the location of the facility on the map. The display method includes a step of setting a future date and time as a target date and time, a step of recognizing the state of the facility at the target date and time based on schedule information of the facility, and a step of displaying the state image corresponding to the state of the facility at the target date and time.

With a configuration according to the present invention, a state image corresponding to the state of a facility at a future date and time (target date and time) is displayed at the location of the facility on the map; thus, it is possible to report to a user, in addition to the location of the facility, also the future state of the facility. This improves convenience for the user who wants to know the future state of the facility. Displaying the state image on the map to report the future state of the facility allows the user to recognize, in addition to the location of the facility, the future state of the facility by simply viewing the displayed map, and this is convenient for the user.

### Advantageous Effects of the Invention

With the configuration according to the present invention, it is possible to report a future state of a facility to a user.

### BRIEF DESCRIPTION OF DRAWINGS

FIG. 1 A diagram showing a display system according to one embodiment of the present invention.

FIG. 2 A diagram showing a state where a state image indicating the current state of a facility is arranged on a map displayed on a display input device in the display system according to the one embodiment of the present invention.

FIG. 3 A diagram illustrating different kinds of state image displayed on the display input device in the display system according to the one embodiment of the present invention.

FIG. 4 A conceptual diagram of schedule information (schedule information of a facility A) stored in a server of the display system according to the one embodiment of the present invention.

FIG. 5 A conceptual diagram of the schedule information (schedule information of a facility B) stored in the server of the display system according to the one embodiment of the present invention.

FIG. 6 A conceptual diagram of the schedule information (schedule information of a facility C) stored in the server of the display system according to the one embodiment of the present invention.

FIG. 7 A diagram showing a state where first and second operation images are arranged on the map displayed on the display input device in the display system according to the one embodiment of the present invention.

FIG. 8 A diagram showing a state where a third operation image is arranged on the map displayed on the display input device in the display system according to the one embodiment of the present invention.

FIG. 9 A diagram illustrating future state reporting processing in a first mode performed by the display input device in the display system according to the one embodiment of the present invention.

FIG. 10 A conceptual diagram of the schedule information (schedule information of the facility A) stored in the server of the display system according to the one embodiment of the present invention.

FIG. 11 A conceptual diagram of the schedule information (schedule information of the facility B) stored in the server of the display system according to the one embodiment of the present invention.

FIG. 12 A conceptual diagram of schedule information (schedule information of the facility C) stored in the server of the display system according to the one embodiment of the present invention.

FIG. 13 A diagram illustrating future state reporting processing in a second mode performed by the display input device in the display system according to the one embodiment of the present invention.

FIG. 14 A conceptual diagram of the schedule information (schedule information of the facility A) stored in the server of the display system according to the one embodiment of the present invention.

### DESCRIPTION OF EMBODIMENTS

<<Structure of Display System>>

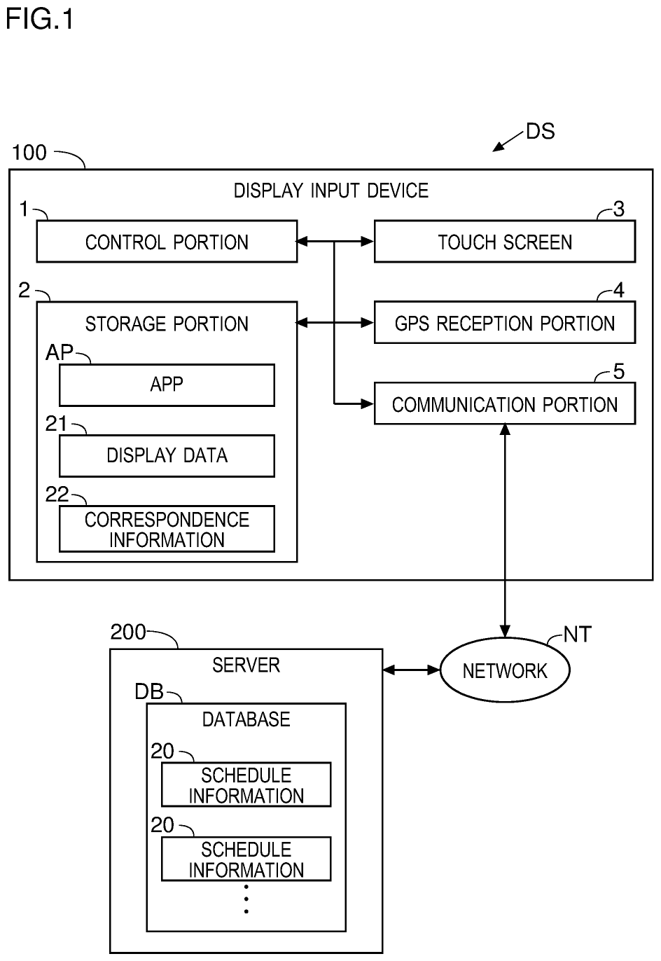

As shown in FIG. 1, a display system DS according to one embodiment is provided with a display input device 100 and a server 200.

The display input device 100 is a mobile communication terminal such as a smartphone and a tablet computer. The display input device 100 is not limited to a mobile communication terminal; it may be any of various types of devices such as a personal computer (PC) and a vehicle-mounted device in a car navigation system.

The display input device 100 is provided with a control portion 1. The control portion 1 includes a processing circuit such as a CPU. The control portion 1 performs processing for controlling different parts of the display input device 100 based on a control program and control data.

The display input device 100 is provided with a storage portion 2. The storage portion 2 includes a non-volatile memory (ROM) and a volatile memory (RAM). The storage portion 2 is connected to the control portion 1. The control program and the control data are stored in the storage portion 2.

On the display input device 100 is installed an application AP (hereinafter, referred to as app AP) for using a facility state reporting service, which will be described later. The app AP is stored in the storage portion 2.

The display input device 100 is provided with a touch screen 3. The touch screen 3 corresponds to “an operation display portion”. The touch screen 3 includes a liquid crystal display panel and a touch panel. The touch screen 3 displays a screen and accepts from a user touch operations on the display screen (touch operations on software buttons arranged on the screen). The touch screen 3 is connected to the control portion 1. The control portion 1 controls the display operation by the touch screen 3 and senses touch operations on the touch screen 3.

The display input device 100 is provided with a GPS reception portion 4. The GPS reception portion 4 includes a GPS antenna. The GPS reception portion 4 receives a GPS signal transmitted from a GPS satellite. The control portion 1 recognizes the current location of the display input device 100 (device itself) based on the GPS signal received by the GPS reception portion 4.

The display input device 100 is provided with a communication portion 5. The communication portion 5 is a communication interface for connecting the display input device 100 to a network NT such as the Internet and includes a communication circuit, a communication memory, and so on. The communication portion 5 is connected to the control portion 1. The control portion 1 communicates with an external device connected to the network NT using the communication portion 5.

The server 200 is maintained by a provider of the facility state reporting service. The facility state reporting service reports the states of facilities previously registered by the service provider to a user of the display input device 100 on which the app AP is installed. By receiving the facility state reporting service, the user can recognize the state of various facilities such as, for example, eating facilities, retail stores, lodging facilities, amusement facilities, cultural facilities, public facilities, and parking facilities.

The server 200 stores a database DB used in the facility state reporting service. The database DB stores schedule information 20 about facilities on a facility by facility basis. The schedule information 20 includes at least information about the schedule of facilities for a predetermined period (for example, for several months). When there is a notification of a schedule change from a facility to the service provider, the schedule information 20 of the facility that has given the notification is updated by the service provider. Also schedule information 20 for which the predetermined period has expired is updated by the service provider.

The schedule information 20 has defined in it, for each date, the time at which a facility opens (the opening time, the service start time, the business start time, the reception start time, etc.) and the time at which a facility closes (the closing time, the service end time, the business end time, the reception end time, etc.). Furthermore, the schedule information 20 also has defined in it the dates on which a facility is closed.

The schedule information 20 may include other information. The schedule information 20 of a lodging facility may include, for example, booking state information that indicates, for each date, the booking state at the time point of updating of the schedule information 20. The schedule information 20 of a parking facility may include fullness state information indicating its fullness state. When the schedule information 20 includes the fullness state information, the fullness state information is updated every several minutes to several hours.

The server 200 is connected to the network NT. This makes communication between the display input device 100 and the server 200 via the network NT possible. The display input device 100 accesses the database DB through communication with the server 200.

<<Facility State Reporting Service>>

<Reporting of the Current State>

In order to use the facility state reporting service, it is necessary to start the app AP installed on the display input device 100. The control portion 1, upon recognizing that a touch operation requesting starting up of the app AP is performed on the touch screen 3, starts up the app AP. Then, the control portion 1 performs processing for establishing communication with the server 200. When communication between the display input device 100 and the server 200 is established, map data is transmitted from the server 200 to the display input device 100.

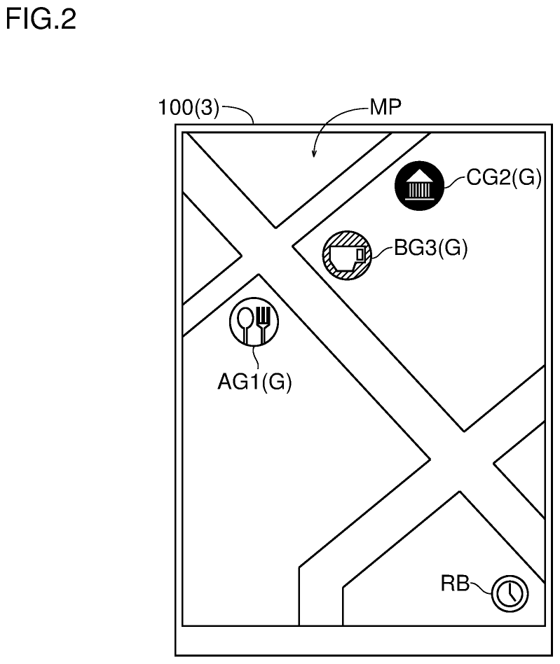

When the communication portion 5 receives map data, as shown in FIG. 2, the control portion 1 displays a map MP on the touch screen 3. Here, the control portion 1 controls the display operation by the touch screen 3 such that the displayed range of the map MP covers the current location of the display input device 100 (device itself).

The touch screen 3, while displaying the map MP, accepts from a user a scroll operation for scrolling the display range of the map MP. For example, an operation in which the touched position is moved while the touch screen 3 is kept touched is accepted as a scroll operation. When a scroll operation is sensed, the control portion 1 makes the display range of the map MP scroll in accordance with the amount of movement of the touched position.

In addition to map data, location data indicating locations of facilities is transmitted from the server 200 to the display input device 100. The location data of facilities is received by the communication portion 5. The control portion 1, based on the location data of facilities, judges whether there is a facility located in an area within the currently displayed range of the map MP (a facility of which the state needs to be reported), and sets a facility located in the area within the currently displayed range of the map MP (a facility of which the state needs to be reported) as a target facility. Then, the control portion 1 displays a state image G indicating the state of the target facility at the location of the target facility on the map MP.

Display data 21 of state images G (see FIG. 1) is stored in the storage portion 2 in advance. Also correspondence information 22 (see FIG. 1) indicating correspondence between state images G and facilities is stored in the storage portion 2 in advance. The control portion 1 recognizes the state image G corresponding to the target facility and displays the recognized state image G at the location of the target facility on the map MP.

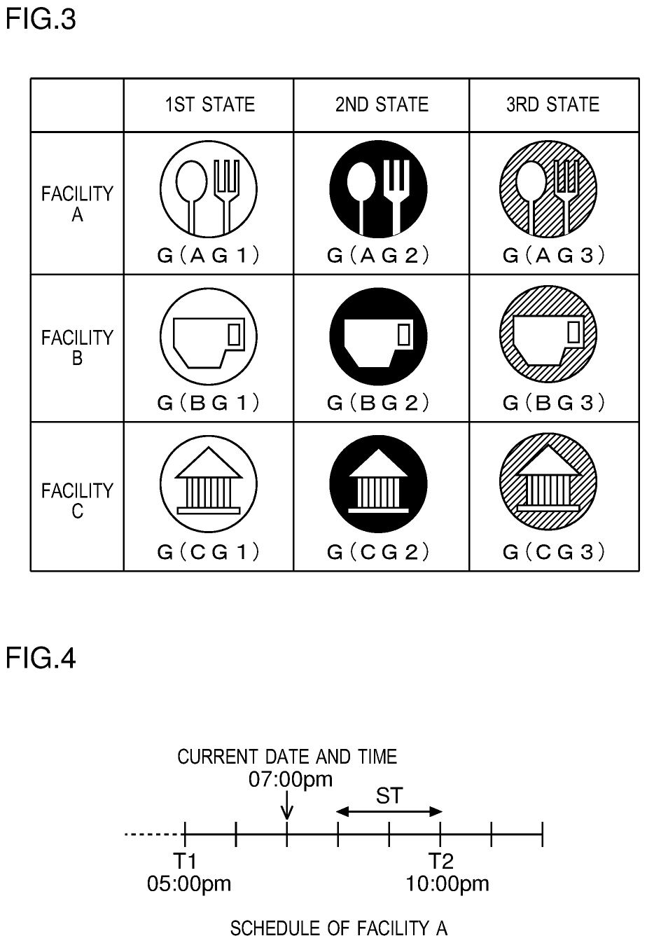

Here, as shown in FIG. 3, the appearance (such as pattern, color, shape, and size) of state images G differs depending on facility type. FIG. 3 shows, as one example, the respective state images G of facilities A, B, and C. For example, the facilities A and B are eating facilities, and the facility C is a cultural facility. A user can freely set the appearance of the state image G for each facility.

Different states of facilities are classified into a plurality of states in advance. They are classified into, for example, three states, namely a first state (a state where a facility is open), a second state (a state where a facility is closed), and a third state (which will be described later). For each facility, a plurality of state images G respectively corresponding to a plurality of states of the facility are stored in the storage portion 2 in advance. When different states of facilities are classified into three states, namely a first to a third state, as shown in FIG. 3, there are three state images G for each facility.

The appearance of state images G differs depending on facility type and also on facility state. That is, the state image G for the first state, the state image G for the second state, and the state image G for the third state differ from each other. In the following description, the state image G corresponding to the facility A in the first state is identified by the reference sign AG1, the state image G corresponding to the facility A in the second state is identified by the reference sign AG2, and the state image G corresponding to the facility A in the third state is identified by the reference sign AG3. The state image G corresponding to the facility B in the first state is identified by the reference sign BG1, the state image G corresponding to the facility B in the second state is identified by the reference sign BG2, and the state image G corresponding to the facility B in the third state is identified by the reference sign BG3. The state image G corresponding to the facility C in the first state is identified by the reference sign CG1, the state image G corresponding to the facility C in the second state is identified by the reference sign CG2, and the state image G corresponding to the facility C in the third state is identified by the reference sign CG3.

The third state is a state which is freely set by a facility or a user. For example, a specific time zone from the time at which the facility closes back to the time a predetermined time earlier (for example, several tens of minutes to several hours earlier) is set in advance. Then, the state of the facility during the specific time zone (that is, the state where the facility's closing time is nearing) is set as the third state.

The control portion 1, when a state image G of a target facility is displayed, refers to the schedule information 20 of the target facility stored in the server 200, and based on the schedule information 20 of the target facility, recognizes the state of the target facility at the current date and time. The control portion 1 extracts, out of a plurality of state images G corresponding to the target facility, the state image G corresponding to the state of the target facility at the current date and time, and displays the extracted state image G at the location of the target facility on the map MP.

For one example, suppose that the current date and time is 7 p.m. on July 12. Suppose also that the control portion 1 has recognized the facilities A to C as the target facilities (suppose that the respective locations of the facilities A to C are within the currently displayed range of the map MP).

In this example, the control portion 1 refers to the respective schedule information 20 of the facilities A to C and recognizes the state of each of the facilities A to C at the current date and time. The control portion 1 also recognizes the specific time zone. Here, suppose that the time zone from the time at which a facility closes back to the time two hours earlier is set as the specific time zone. In the following description, the time at which the facility opens is identified by the reference sign T1, the time at which the facility closes is identified by the reference sign T2, and the specific time zone is identified by a reference sign ST.

Here, suppose that, in the schedule information 20 of the facility A, a schedule as shown in FIG. 4 is defined as the schedule corresponding to the current date. That is, the time T1 at which the facility A opens is 5 p.m., the time T2 at which the facility A closes is 10 p.m., and the specific time zone ST is from 8 p.m. to 10 p.m. In this example, the facility A is currently open, and the current time is not in the specific time zone ST. Thus, the control portion 1 recognizes that the state of the facility A at the current date and time is the first state. Accordingly, as shown in FIG. 2, the state image AG1 (see FIG. 3) is displayed at the location of the facility A on the displayed map MP.

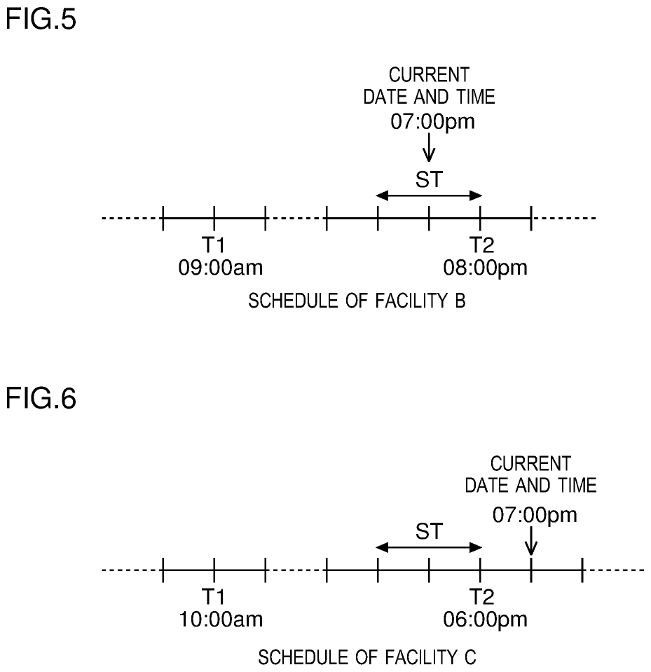

Likewise, suppose that, in the schedule information 20 of the facility B, a schedule as shown in FIG. 5 is defined as the schedule corresponding to the current date. That is, the time T1 at which the facility B opens is 9 a.m., the time T2 at which the facility B closes is 8 p.m., and the specific time zone ST is from 6 p.m. to 8 p.m. In this example, the facility B is currently open, and the current time is in the specific time zone ST. Thus, the control portion 1 recognizes that the state of the facility B at the current date and time is the third state. Accordingly, as shown in FIG. 2, the state image BG3 (see FIG. 3) is displayed at the location of the facility B on the displayed map MP.

Likewise, suppose that, in the schedule information 20 of the facility C, a schedule as shown in FIG. 6 is defined as the schedule corresponding to the current date. That is, the time T1 at which the facility C opens is 10 a.m., the time T2 at which the facility C closes is 6 p.m., and the specific time zone ST is from 4 p.m. to 6 p.m. In this example, the facility C is currently closed. Thus, the control portion 1 recognizes that the state of the facility C at the current date and time is the second state. Accordingly, as shown in FIG. 2, the state image CG2 (see FIG. 3) is displayed at the location of the facility C on the displayed map MP.

As a modified example, different states of a lodging facility may be classified into three states, namely a state where there are plenty of vacancies (a first state), a state where there is no vacancy (a second state), and a state where there are few vacancies (a third state).

In this case, the control portion 1, when it recognizes the lodging facility as the target facility, based on the booking state information included in the schedule information 20 of the lodging facility, recognizes the booking state of the lodging facility at the current date and time. Then, although not illustrated, the control portion 1, when there are plenty of vacancies, displays the state image G corresponding to the first state of the lodging facility at the location of the lodging facility on the map MP; when there is no vacancy, displays the state image G corresponding to the second state of the lodging facility at the location of the lodging facility on the map MP; and when there are few vacancies, displays the state image G corresponding to the third state of the lodging facility at the location of the lodging facility on the map MP.

As another modified example, different states of a parking facility may be classified into three states, namely a state where there are plenty of vacancies (a first state), a state where there is no vacancy (a second state), and a state where there are few vacancies (a third state).

In this case, although unillustrated, the control portion 1, when it recognizes the parking facility as the target facility, based on the fullness state information included in the schedule information 20 of the parking facility, recognizes the fullness state of the lodging facility at the current date and time. As a result, the control portion 1, when there are vacancies, displays the state image G corresponding to the first state of the parking facility at the location of the parking facility on the map MP; when there is no vacancy, displays the state image G corresponding to the second state of the parking facility at the location of the parking facility on the map MP; and when there are few vacancies, displays the state image G corresponding to the third state of the parking facility at the location of the parking facility on the map MP.

<Reporting of the Future State>

The control portion 1 performs future state reporting processing for reporting a future state of a facility. The control portion 1 performs future state reporting processing in either a first and a second mode. In which of the first and second modes the control portion 1 performs future state reporting processing is set by a user. A mode setting is accepted from a user by the touch screen 3.

(First Mode)

In the first mode, a user can freely specify a date and time in the future. The control portion 1 sets the future date and time specified by a user as a target date and time. Then, the control portion 1 performs, as future state reporting processing, processing for reporting the state of a facility at the future date and time (target date and time) specified by the user. In future state reporting processing, a facility located in an area within the currently displayed range of the map MP is set as a target facility (a facility of which the state needs to be reported).

In order to accept specification of a future date and time, a specification button RB (see FIG. 2) is displayed on the touch screen 3. The touch screen 3 displays the specification button RB on the map MP.

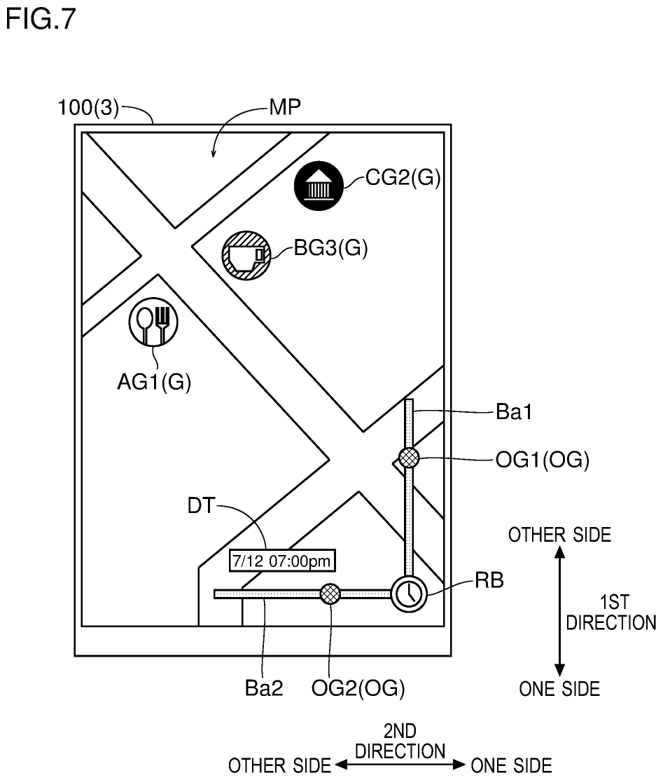

The control portion 1, upon detecting an operation on the specification button RB is detected, as shown in FIG. 7, makes the touch screen 3 display a first operation image OG1 and a second operation image OG2. The first operation image OG1 is movable in a first direction (up-down direction in FIG. 7), and the second operation image OG2 is movable in a second direction (left-right direction in FIG. 7) in the second direction. The first operation image OG1 can be moved by touching the first operation image OG1 and, while keeping touching it, moving the touched position in the first direction. The second operation image OG2 can be moved in the second direction by touching the second operation image OG2 and, while keeping touching it, moving the touched position in the second direction. In the following description, for the sake of convenience, the first and second operation images OG1 and OG2 are occasionally referred to as the operation image OG collectively.

The touch screen 3 displays, along with the first and second operation images OG1 and OG2, a first bar image Ba1 that extends in the first direction and a second bar image Ba2 that extends in the second direction. The moving range of the first operation image OG1 is indicated by the first bar image Ba1, and the moving range of the second operation image OG2 is indicated by the second bar image Ba2.

The length of the first bar image Ba1 in the first direction corresponds to the hours of one day (24 hours). One end of the first bar image Ba1 in the first direction corresponds to 0 a.m., and a point short of the other end of the first bar image Ba1 opposite to the one end in the first direction corresponds to 11:59 p.m. The length of the second bar image Ba2 in the second direction corresponds to the number of days in one month. One end of the second bar image Ba2 in the second direction corresponds to the first day of the month, and a point short of the other end of the second bar image Ba2 opposite to the one end in the second direction corresponds to the last day of the month.

The control portion 1, when displaying the operation image OG, recognizes the current date and time. The control portion 1 requests the touch screen 3 to display the first operation image OG1 at a position corresponding to the current time on the first image Ba1 and also to display the second operation image OG2 at a position corresponding to the current date on the second bar image Ba2. The control portion 1 makes the touch screen 3 display a date and time image DT that indicates the date and time indicated by the positions of the first and second operation images OG1 and OG2.

The touch screen 3 accepts an operation in which the operation image OG is moved as a date and time specification operation (an operation for specifying a future date and time). The control portion 1, upon detecting a date and time operation, recognizes the position of the operation image OG after the date and time specification operation. Then, the control portion 1 sets the date and time corresponding to the position of the recognized operation image OG as a target date and time. As the operation image OG moves, depending on the position of the operation image OG, the date and time indicated by the date and time image DT changes. That is, the date and time indicated by the date and time image DT displayed after the date and time specification operation is the target date and time.

The control portion 1, when an operation in which the first operation image OG1 is moved from one side in the first direction toward the other side is performed, advances the target time. The control portion 1, when an operation in which the second operation image OG2 is moved from one side in the second direction toward the other side is performed, advances the target date.

The control portion 1, when the first operation image OG1 moves up to the other end of the first bar image Ba1 in the first direction, changes the target date to the date of the next day. Here, the touch screen 3 switches the position at which the first operation image OG1 is displayed to the one end of the first bar image Ba1 in the first direction. Then, the touch screen 3 accepts a date and time specification operation. For example, when the current date and time is 8 p.m. on July 12, if the first operation image OG1 moves up to the other end of the first bar image Ba1 in the first direction, the target date becomes 0 a.m. on July 13.

The control portion 1, when the second operation image OG2 moves up to the other end of the second bar image Ba2 in the second direction, changes the target date to the date of the next month (this month's first day). Here, the touch screen 3 switches the position at which the second operation image OG2 is displayed to the one end of the second bar image Ba2 in the second direction. Then, the touch screen 3 accepts a date and time specification operation. For example, when the current date and time is 8 p.m. on July 12, if the second operation image OG2 moves to the other end of the second bar image Ba2 in the second direction, the target date becomes 8 p.m. on July 13.

There is no particular limitation on the operation allocated to date specification. For example, by displaying a date and time specification clock (unillustrated), an operation of moving the long and short hands of the date and time specification clock may be allocated to a date specification operation so that the time indicated by the long and short hands after the date and time specification operation may be set as a target time. Also, by displaying a date and time specification calendar (unillustrated), an operation of touching a date on the calendar may be allocated to a date and time specification operation so that the touched date is set as a target date.

In addition, a user may be allowed to select freely whether to specify a future date and time using the operation image OG or using the date and time specification clock and calendar. In such a configuration, for example, the control portion 1, upon detecting a touch operation where the specification button RB is tapped once, makes the touch screen 3 display the operation image OG, and, upon detecting a touch operation in which the specification button RB is tapped twice successively or a touch operation that lasts longer than a predetermined time (long-press operation), makes the touch screen 3 display the date and time specification clock and calendar.

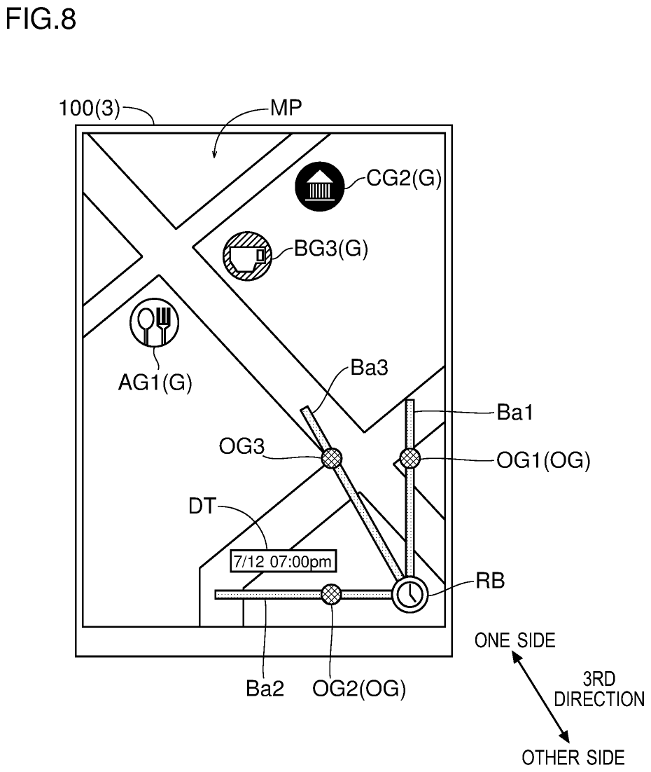

As a modified example, when a date and time specification operation is accepted, in addition to the first and second operation images OG1 and OG2, as shown in FIG. 8, a third operation image OG3 may be displayed on the touch screen 3. The third operation image OG3 is movable in a third direction. The third direction is, for example, a direction between the first and second directions (that is, an oblique direction). The third operation image OG3 can be moved by touching the third operation image OG3 and, while keeping touching it, moving the touched position in the third direction. The touch screen 3 displays, along with the third operation image OG3, a third bar image Ba3 that extends in the third direction. The moving range of the third operation image OG3 is indicated by the third bar image Ba3.

The control portion 1, when an operation in which the third operation image OG3 is moved in the third direction is performed, detects the operation as a date and time specification operation (operation for specifying a future date and time). The control portion 1, when an operation in which the third operation image OG3 is moved from one side in the third direction toward the other side is performed, advances both the target date and time. When the third operation image OG3 is moved in the third direction and the target date and time changes accordingly, in accordance with the change in the target date and time, also the positions of the first and second operation images OG1 and OG2 change.

The moving direction (third direction) of the third operation image OG3, that is, the inclination angle of the third bar image Ba3 may be freely changed by a user. When the inclination angle of the third bar image Ba3 is changed such that the third direction becomes closer to the first direction (the state shown in FIG. 8), with respect to the amount of advancement of the target time, the amount of advancement of the target date becomes smaller. On the other hand, although not illustrated, when the inclination angle of the third bar image Ba3 is changed such that the third direction becomes closer to the second direction, with respect to the amount of advancement of the target date, the amount of advancement of the target time becomes smaller.

After a target date and time (future date and time) is set based on a date and time specification operation, the control portion 1 performs processing similar to the processing for reporting the state of a target facility at the current date and time. That is, the control portion 1, based on the schedule information 20 for the target facility, recognizes the state of the target facility at the target date and time. The control portion 1 extracts, out of a plurality of state images G for the target facility, the state image G corresponding to the state of the target facility at the target date and time, and displays the extracted state image G at the location of the target facility on the map MP.

For one example, suppose that, when the current date and time is 7 p.m. on July 12, the control portion 1 recognizes facilities A to C as target facilities. In addition, suppose that the time zone from the time at which a facility closes back to the time two hours earlier is set as the specific time zone. In the following description, the time at which the facility opens is identified by the reference sign T1, the time at which the facility closes is identified by the reference sign T2, and the specific time zone is identified by a reference sign ST.

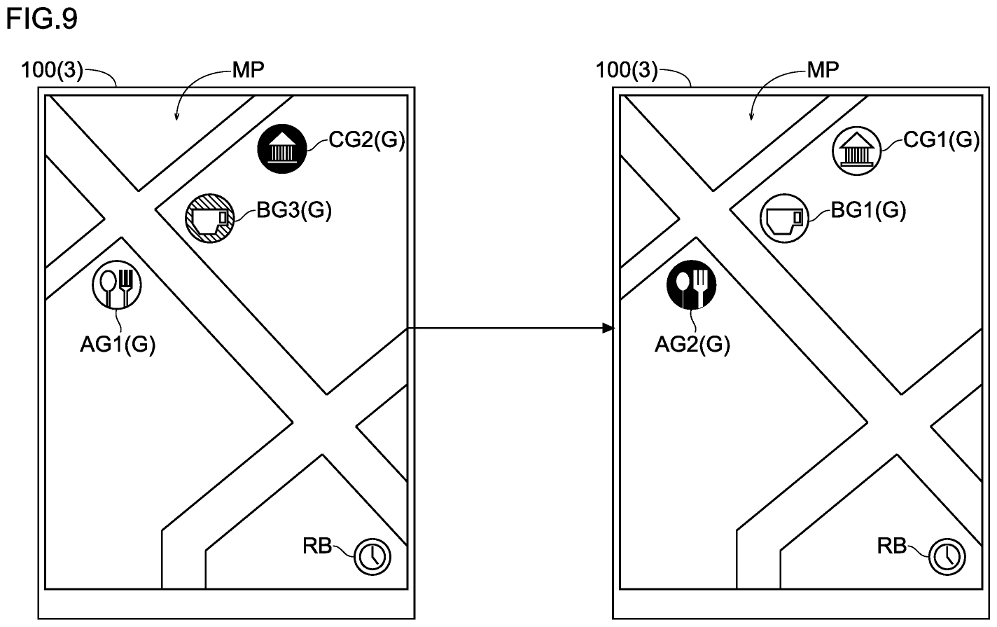

In this example, before a user performs a date and time specification operation, state images G as shown in the left image in FIG. 9 are displayed on the map MP (the same screen as the one shown in FIG. 2 is displayed on the display input device 100). That is, the state image AG1 is displayed at the location of the facility A on the displayed map MP, the state image BG3 is displayed at the location of the facility B on the displayed map MP, and the state image CG2 is displayed at the location of the facility C on the displayed map MP.

Then, suppose that, after the state images AG1, BG3, and CG2 are displayed, a user performs a date and time specification operation. Here, the control portion 1 sets a target date and time (future date and time). For example, suppose that the target date and time set by the control portion 1 is 3 p.m. on July 20.

In this case, the control portion 1 refers to the respective schedule information 20 of the facilities A to C and recognizes the state of each of the facilities A to C at the target date and time. The control portion 1 also recognizes the specific time zone ST.

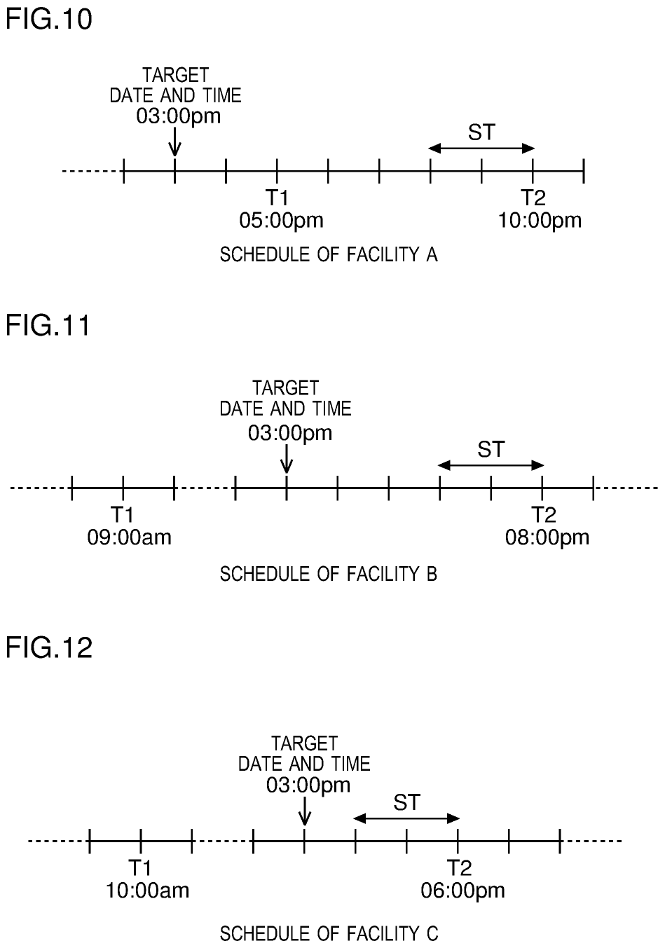

Here, suppose that, in the schedule information 20 of the facility A, a schedule as shown in FIG. 10 is defined as the schedule corresponding to the target date. That is, the time T1 at which the facility A opens is 5 p.m., the time T2 at which the facility A closes is 10 p.m., and the specific time zone ST is from 8 p.m. to 10 p.m. In this example, the facility A is closed at the time point of the target date and time. Thus, the control portion 1 recognizes that the state of the facility A at the target date and time is the second state.

Likewise, suppose that, in the schedule information 20 of the facility B, a schedule as shown in FIG. 11 is defined as the schedule corresponding to the target date. That is, the time T1 at which the facility B opens is 9 a.m., the time T2 at which the facility B closes is 8 p.m., and the specific time zone ST is from 6 p.m. to 8 p.m. In this example, the facility B is open at the time point of the target date and time, and the target time is not in the specific time zone ST. Thus, the control portion 1 recognizes that the state of the facility B at the target date and time is the first state.

Likewise, suppose that, in the schedule information 20 of the facility C, a schedule as shown in FIG. 12 is defined as the schedule corresponding to the target date. That is, the time T1 at which the facility C opens is 10 a.m., the time T2 at which the facility B closes is 6 p.m., and the specific time zone ST is from 4 p.m. to 6 p.m. In this example, the facility C is open at the time point of the target date and time, and the target time is not in the specific time zone ST. Thus, the control portion 1 recognizes that the state of the facility C at the target date and time is the first state.

As a result, after a date and time specification operation is performed, the screen of the display input device 100 changes from the left one in FIG. 9 to the right one in FIG. 9. That is, the state image AG2 is displayed at the location of the facility A on the displayed map MP, the state image BG1 is displayed at the location of the facility B on the displayed map MP, and the state image CG1 is displayed at the location of the facility C on the displayed map MP.

(Second Mode)

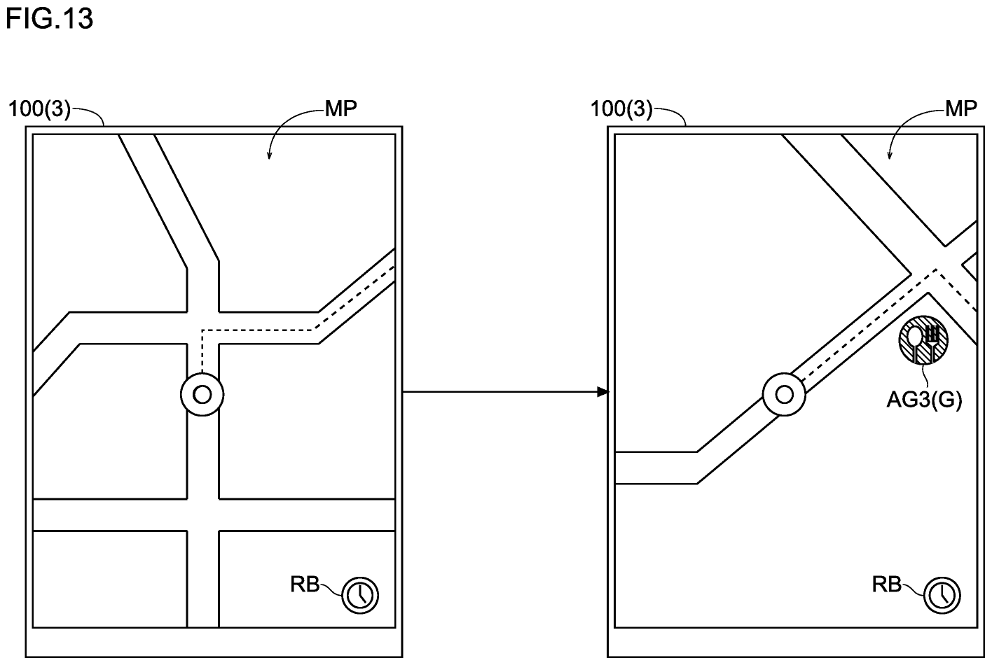

In the second mode, the display input device 100 functions as a navigation system. That is, the control portion 1 makes the touch screen 3 accept an operation for setting a destination. When a destination is set, the control portion 1 performs route search processing for searching for a route from the current location of the display input device 100 (device itself) to the destination. For example, a route search program is stored in the storage portion 2 in advance, and route search processing is performed by the control portion 1 based on the route search program. Then, the control portion 1, as shown in FIG. 13, makes the touch screen 3 display a line image (indicated by a broken line) showing the route searched for by route search processing. A user then starts to move while checking the route displayed on the display input device 100.

The control portion 1, after future state reporting processing in the second mode is started, continues detecting the current location of the display input device 100 (device itself). Then, the control portion 1, in accordance with the change in the current location of the display input device 100, scrolls the displayed range of the map MP. For example, the displayed range of the map MP is scrolled so that the center of the displayed range of the map MP is the current location of the display input device 100.

Here, suppose that, at the start of future state reporting processing in the second mode, there is no facility of which the state needs to be reported (no facility registered by the service provider) in the area within the displayed range of the map MP. Then, suppose that, after future state reporting processing in the second mode is started, as a user moves, the location of a facility enters the displayed range of the map MP.

Here, the control portion 1 recognizes the facility that has entered the displayed range of the map MP as a target facility (a facility of which the state needs to be reported), and performs processing for setting a future date and time as a target date and time. Specifically, the control portion 1 recognizes the current location of the display input device 100 (device itself) and, based on the distance from the current location to the location of the target facility and the moving speed of the user (the moving speed is previously set by the user), calculates an estimated arrival date and time from the current location to the target location. Then, the control portion 1 sets the estimated arrival date and time as a target date and time.

The control portion 1 accesses schedule information 20 of the target facility stored in the server 200 and, based on the schedule information 20 of the target facility, recognizes the state of the target facility at the target date and time (estimated arrival date and time). Then, the control portion 1 extracts, out of a plurality of state images G for the target facility, the state image G corresponding to the state of the target facility at the target date and time, and displays the extracted state image G at the location of the target facility on the map MP.

For one example, the control portion 1 recognizes a facility A as a target facility and sets the target date (estimated arrival time) at 9 p.m. on July 30. In addition, suppose that the time zone from the time at which a facility closes back to the time two hours earlier is set as the specific time zone. In the following description, the time at which the facility opens is identified by the reference sign T1, the time at which the facility closes is identified by the reference sign T2, and the specific time zone is identified by a reference sign ST.

In this case, the control portion 1 refers to the schedule information 20 of the facility A and recognizes the state of the facility A at the target date and time (estimated arrival date and time). The control portion 1 also recognizes the specific time zone ST.

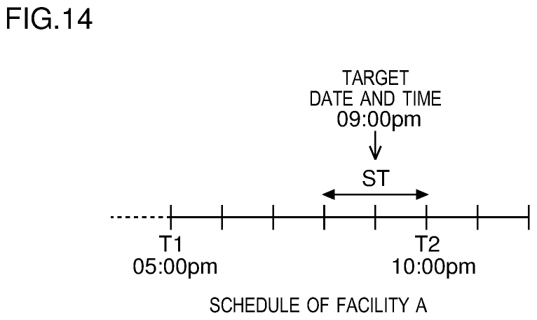

Here, suppose that, in the schedule information 20 of the facility A, a schedule as shown in FIG. 14 is defined as the schedule corresponding to the target date (estimated arrival date). That is, the time T1 at which the facility A opens is 5 p.m., the time T2 at which the facility A closes is 10 p.m., and the specific time zone ST is from 8 p.m. to 10 p.m. In this example, the facility A is open at the time point of the target date and time, but the target time is in the specific time zone ST. Thus, the control portion 1 recognizes that the state of the facility A at the target date and time is the third state.

As a result, the screen of the display input device 100 changes from the left one in FIG. 13 to the right one in FIG. 13. That is, the state image AG3 is displayed at the location of the facility A on the displayed map MP.

After the control portion 1 sets the target date and time (after the estimated arrival date and time is calculated), for example, the moving speed of a user may change. When the user increases the moving speed, the estimated arrival date and time is advanced, and when the user decreases the moving speed, the estimated arrival date and time is deferred. Thus, the control portion 1, after the location of the target facility enters the displayed range of the map MP (after the state image G is first displayed), calculates the estimated arrival date and time repeatedly to update the target date and time. Then, the control portion 1 displays the state image G corresponding to the state of the target facility at the latest target date and time (estimated arrival date and time) at the location of the target facility on the map MP.

With the configuration of this embodiment, as described above, the state image G corresponding to the state of a facility at a future date and time (target date and time) is displayed at the location of the facility on the map MP; thus, it is possible to report to a user, in addition to the location of the facility, also the future state of the facility. This improves convenience for the user who wants to know the future state of the facility. Displaying the state image G on the map MP to report the future state of the facility allows the user to recognize, in addition to the location of the facility, the future state of the facility by simply viewing the displayed map MP, and this is convenient for the user.

In this embodiment, as described above, the storage portion 2 stores, for each facility, three state images G respectively corresponding to three different states of the facility. The control portion 1 makes the touch screen 3 display the state image G stored in the storage portion 2 corresponding to the state of the facility at the target date and time. With this configuration, it is possible to specifically recognize the state of the facility, such as not only whether the facility is open or closed but also whether the closing time of the facility is nearing, and this is convenient for the user. Furthermore, since the appearance of the three state images G differs from each other, at a mere glance of the state image G, it is possible to recognize the state of the facility easily.

In addition, in this embodiment, as mentioned above, when the mode related to future state reporting processing is set to the first mode, the control portion 1: recognizes the state of the facility at the current date and time based on the schedule information 20; makes the touch screen 3 display the state image G corresponding to the state of the facility at the current date and time until the specification button RB is operated; sets the target date and time when the specification button is operated; and makes the touch screen 3 display the state image G corresponding to the state of the facility at the target date and time. With this configuration, it is possible to recognize not only the future state of the facility but also the current state of the facility, and this is convenient for the user.

In addition, in this embodiment, as described above, when the mode related to future state reporting processing is set to the first mode, the control portion 1 advances the target time when an operation in which the first operation image OG1 is moved from one side in the first direction toward the other side is performed, and advances the target date when an operation in which the second operation image OG2 is moved from one side in the second direction toward the other side is performed. In addition, the control portion 1 changes the target date to the date of the next day when the first operation image OG1 moves up to the other end of the moving range of the first operation image OG1 in the first direction, and changes the target date to the date of the next month when the second operation image OG2 moves up to the other end of the moving range of the second operation image OG2 in the second direction. With this configuration, the future date and time set as the target date and time can be changed in accordance with the amount of movement of the operation image OG (first and second operation images OG1 and OG2), and this improves operability (restrains an increase in the number of operation steps). The operation is also intuitive and easy to understand.

In the modified example in which the third operation image OG3 is displayed, the future date and time set as the target date and time can be changed at once, and this further improves operability.

In addition, in this embodiment, as mentioned above, when the mode related to future state reporting processing is set to the second mode, the control portion 1: calculates an estimated arrival date and time from the current location of the display input device 100 (device itself) recognized based on the GPS signal to the facility when the location of the facility enters the displayed range of the map MP; sets the estimated arrival date and time as a target date and time; and makes the touch screen 3 display the state image G corresponding to the state of the facility at the estimated arrival date and time which is set as the target date and time. With this configuration, when the display input device 100 is used as a navigation system, it is not necessary to perform an operation of specifying a future date and time which is set as a target date and time, and this is convenient for the user. For example, by setting the mode related to future state reporting processing to the second mode, when a user wants to know the future state of the facility while driving a vehicle, it is not necessary to stop the vehicle to operate the display input device 100.

In addition, in this embodiment, as mentioned above, when the mode related to future state reporting processing is set to the second mode, the control portion 1 calculates the estimated arrival date and time repeatedly after the location of the facility enters the displayed range of the map MP, and makes the touch screen 3 display the state image G corresponding to the state of the facility at the latest estimated arrival date and time. With this configuration, even when, for example, the estimated arrival date and time changes due to a significant change in the moving speed of the user, it is possible to display the state image G corresponding to the state of the facility at an updated estimated arrival date and time.

The embodiments disclosed herein should be understood to be in every aspect illustrative and not restrictive. The scope of the present disclosure is defined not by the description of the embodiments given above but by the appended claims, and should be understood to encompass any modifications made in the sense and scope equivalent to those of the claims.

1: A display input device comprising:
an operation display portion which displays a map and which displays a state image indicating a state of a facility at a location of the facility on the map; and
a control portion
which sets a future date and time as a target date and time
which recognizes a state of the facility at the target date and time based on schedule information of the facility, and
which displays the state image corresponding to the state of the facility at the target date and time on the operation display portion.

2: The display input device according to claim 1,
wherein
different states of the facility are classified into a plurality of states,
the display input device further comprises a storage portion which stores a plurality of the state images respectively corresponding to the plurality of states of the facility, and
the control portion makes the operation display portion display, out of the plurality of state images stored in the storage portion, the state image corresponding to the state of the facility at the target date and time.

3: The display input device according to claim 1,
wherein
the operation display portion displays a specification button for accepting specification of the future date and time, and
the control portion
recognizes the state of the facility at a current date and time based on the schedule information,
makes the operation display portion display the state image corresponding to the state of the facility at the current date and time until the specification button is operated,
sets the target date and time when the specification button is operated, and
makes the operation display portion display the state image corresponding to the state of the facility at the target date and time.

4: The display input device according to claim 3,
wherein
the operation display portion displays, when the specification button is operated, a first operation image which is movable in a first direction and a second operation image which is movable in a second direction, and
the control portion
advances the target time when an operation in which the first operation image is moved from one side in the first direction toward another side is performed, and
advances the target date when an operation in which the second operation image is moved from one side in the second direction toward another side is performed.

5: The display input device according to claim 4,
wherein
the control portion
changes the target date to a date of a next day when the first operation image moves up to another end of a moving range of the first operation image in the first direction, and
changes the target date to a date of a next month when the second operation image moves up to another end of a moving range of the second operation image in the second direction.

6: The display input device according to claim 3,
wherein
the operation display portion displays a third operation image which is movable in a third direction when the specification button is operated, and
the control portion advances both the target date and time when an operation in which the third operation image is moved from one side in the third direction toward another side is performed.

7: The display input device according to claim 1 further comprising a GPS reception portion for receiving a GPS signal,
wherein
the control portion
calculates an estimated arrival date and time from a current location of the display input device recognized based on the GPS signal to the facility when the location of the facility enters a displayed range of the map,
sets the estimated arrival date and time as the target date and time, and
makes the operation display portion display the state image corresponding to the state of the facility at the estimated arrival date and time set as the target date and time.

8: The display input device according to claim 7,
wherein
the control portion
calculates the estimated arrival date and time repeatedly after the location of the facility enters the displayed range of the map, and
makes the operation display portion display the state image corresponding to the state of the facility at the latest estimated arrival date and time.

9: A display system comprising:
the display input device according to claim 1; and
a server which is communicably connected to the display input device and which stores the schedule information of the facility,
wherein
the display input device communicates with the server to refer to the schedule information of the facility when the display input device recognizes the state of the facility at the target date and time.

10: A display method for displaying a map and displaying a state image indicating a state of a facility at a location of the facility on the map, comprising:
a step of setting a future date and time as a target date and time;
a step of recognizing the state of the facility at the target date and time based on schedule information of the facility; and
a step of displaying the state image corresponding to the state of the facility at the target date and time.
